(19) United States
(12) Patent Application Publication
(10) Pub. No.: US 2026/0011048 A1
(43) Pub. Date: Jan. 8, 2026

(54) DATA PROCESSING METHOD FOR A VIRTUAL PERSONA, APPARATUS, ELECTRONIC DEVICE, AND MEDIUM

(71) Applicant: BEIJING BAIDU NETCOM SCIENCE TECHNOLOGY CO., LTD., BEIJING (CN)

(72) Inventors: Zhiqiang WANG, BEIJING (CN); Baoxuan GU, BEIJING (CN); Qin QIN, BEIJING (CN)

(21) Appl. No.: 19/329,257

(22) Filed: Sep. 15, 2025

(30) Foreign Application Priority Data
Dec. 3, 2024 (CN) 202411766312.3

(51) Int. Cl. G06T 11/00; G06V 40/16; G10L 15/02

(52) U.S. Cl. CPC G06T 11/00; G06V 40/168; G10L 15/02

(57) ABSTRACT

A method includes: obtaining audio data and a first target image including the face of a target object; performing a facial landmark extraction on the first target image to obtain a first facial landmark image; performing, based on the audio data, an audio feature extraction to obtain an audio feature; inputting the first facial landmark image and the audio feature into a predefined landmark generation network model to obtain a facial landmark image sequence corresponding to the audio data; obtaining, based on the facial landmark image sequence and the first target image, a video corresponding to the audio data generated based on the first target image.

### CROSS REFERENCE TO RELATED APPLICATION

This application claims priority to Chinese patent application No. 202411766312.3 filed on Dec. 3, 2024, the contents of which are hereby incorporated by reference in their entirety for all purposes.

### TECHNICAL FIELD

The present disclosure relates to the technical field of artificial intelligence, particularly to the technical fields of deep learning, image processing, and digital human, and specifically to a data processing method for a virtual persona, an apparatus, an electronic device, a computer-readable storage medium, and a computer program product.

### DESCRIPTION OF THE RELATED ART

Artificial intelligence is the discipline of studying how computers can simulate certain thinking processes and intelligent behaviors of a human being (such as learning, reasoning, thinking, planning, etc.), and there are both hardware-level and software-level technologies. The artificial intelligence hardware technologies generally include technologies such as sensors, special artificial intelligence chips, cloud computing, distributed storage, big data processing, etc. The artificial intelligence software technologies mainly include computer vision technology, speech recognition technology, natural language processing technology, machine learning/deep learning, big data processing technology, knowledge graph technology and other major technological directions.

With the development of artificial intelligence technology, virtual digital humans have been widely applied in live streaming, news broadcasting, voice prompting, and other fields. Typically, it is necessary to drive, based on an audio to be broadcast, the virtual digital human to perform actions and expressions synchronized with the audio to obtain a video driven by the audio. By using audio-driven, a realistic and expressive portrait video can be generated from a single facial image, which has broad application prospects across various fields, ranging from digital media to gaming, film production and the like.

### BRIEF SUMMARY

This disclosure provides a data processing method, an apparatus, an electronic device, a computer-readable storage medium, and a computer program product for a virtual persona.

According to an aspect of the present disclosure, a data processing method for a virtual persona is provided, including: obtaining audio data and a first target image including the face of a target object; performing, based on the first target image, a facial landmark extraction to obtain a first facial landmark image; performing, based on the audio data, an audio feature extraction to obtain an audio feature; inputting the first facial landmark image and the audio feature into a predefined landmark generation network model to obtain a facial landmark image sequence corresponding to the audio data; and obtaining, based on the facial landmark image sequence and the first target image, a video corresponding to the audio data and generated based on the first target image.

According to another aspect of the present disclosure, a model training method is provided, including: obtaining an audio frame, a first target image including the face of a target object, a first label image, and a second label image, where the first label image is a first face landmark image corresponding to the audio frame and generated based on the first target image, and the second label image is a first image corresponding to the audio frame and generated based on the first target image; performing, based on the first target image, a facial landmark extraction to obtain a second facial landmark image; performing, based on the audio frame, an audio feature extraction to obtain an audio feature; inputting the second facial landmark image and the audio feature into a landmark generation network model to obtain a third facial landmark image corresponding to the audio frame; and determining, based on the third facial landmark image and the first facial landmark image, a first loss value using a predefined first loss function; obtaining, based on the third facial landmark image and the first target image, a second image corresponding to the audio frame and generated based on the first target image using a video generation model; determining, based on the second image and the first image, a second loss value using a predefined second loss function; adjusting, based on the first loss value, parameter values of the landmark generation network model; and adjusting, based on the second loss value, parameter values of the video generation model.

According to another aspect of the present disclosure, an electronic device is provided, including: a memory storing one or more programs configured to be executed by one or more processors, the one or more programs including instructions for performing operations comprising: obtaining audio data and a first target image including the face of a target object; performing, based on the first target image, a facial landmark extraction to obtain a first facial landmark image; performing, based on the audio data, an audio feature extraction to obtain an audio feature; inputting the first facial landmark image and the audio feature into a predefined landmark generation network model to obtain a facial landmark image sequence corresponding to the audio data; and obtaining, based on the facial landmark image sequence and the first target image, a video corresponding to the audio data and generated based on the first target image.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE SEVERAL VIEWS OF THE DRAWINGS

The drawings exemplarily illustrate embodiments and constitute a part of the specification, and are used in conjunction with the textual description of the specification to explain the example implementations of the embodiments. The illustrated embodiments are for illustrative purposes only and do not limit the scope of the claims. Throughout the drawings, like reference numerals refer to similar but not necessarily identical elements.

FIG. 1 illustrates a schematic diagram of an example system in which various methods described herein can be implemented according to embodiments of the present disclosure;

FIG. 2 illustrates a flowchart of a data processing method according to an embodiment of the present disclosure;

FIG. 3 illustrates a schematic diagram of a data processing method according to an embodiment of the present disclosure;

FIG. 4 illustrates a schematic diagram of a facial landmark image sequence generation model according to an embodiment of the present disclosure;

FIG. 5 illustrates a schematic diagram of a video generation model for generating a video according to an embodiment of the present disclosure;

FIG. 6 illustrates a flowchart of a model training method according to an embodiment of the present disclosure;

FIG. 7 illustrates a structural block diagram of a data processing apparatus according to an embodiment of the present disclosure;

FIG. 8 illustrates a structural block diagram of a model training apparatus according to an embodiment of the present disclosure; and

FIG. 9 illustrates a structural block diagram of an example electronic device that can be used to implement embodiments of the present disclosure.

### DETAILED DESCRIPTION

The example embodiments of the present disclosure are described below in conjunction with the accompanying drawings, including various details of the embodiments of the present disclosure to facilitate understanding, and they should be considered as example only. Therefore, one of ordinary skill in the art will recognize that various changes and modifications may be made to the embodiments described herein without departing from the scope of the present disclosure. Similarly, descriptions of well-known functions and structures are omitted in the following description for the purpose of clarity and conciseness.

In the present disclosure, unless otherwise specified, the terms “first”,” second “and the like are used to describe various elements and are not intended to limit the positional relationship, timing relationship, or importance relationship of these elements, and such terms are only used to distinguish one element from another. In some examples, the first element and the second element may refer to the same instance of the element, while in some cases they may also refer to different instances based on the description of the context.

The terminology used in the description of the various examples in this disclosure is for the purpose of describing particular examples only and is not intended to be limiting. Unless the context clearly indicates otherwise, if the number of elements is not specifically defined, the element may be one or more. In addition, the terms “and/or” used in the present disclosure encompass any one of the listed items and all possible combinations thereof.

Embodiments of the present disclosure will be described in detail below with reference to the accompanying drawings.

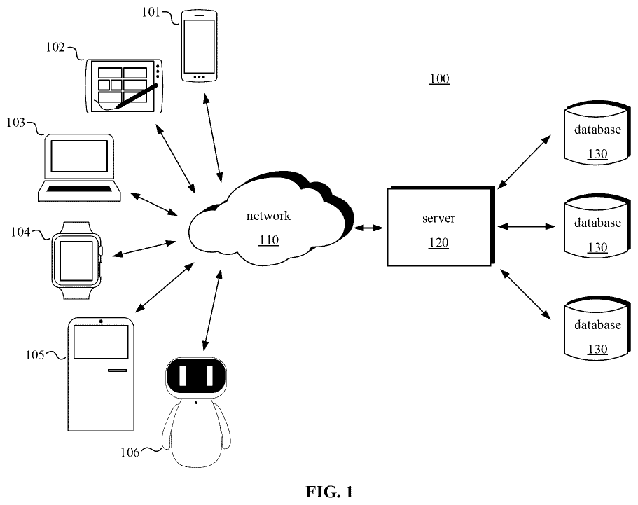

FIG. 1 illustrates a schematic diagram of an example system 100 in which various methods and apparatuses described herein may be implemented in accordance with embodiments of the present disclosure. Referring to FIG. 1, the system 100 includes one or more client devices 101, 102, 103, 104, 105 and 106, a server 120, and one or more communication networks 110 that couple one or more client devices to the server 120. The client devices 101, 102, 103, 104, 105, and 106 may be configured to execute one or more applications.

In embodiments of the present disclosure, the server 120 may run one or more services or software applications that enable execution of the data processing method.

In some embodiments, the server 120 may also provide other services or software applications, which may include non-virtual environments and virtual environments. In some embodiments, these services may be provided as web-based services or cloud services, such as to the user of the client devices 101, 102, 103, 104, 105, and/or 106 under a Software as a Service (SaaS) model.

In the configuration shown in FIG. 1, the server 120 may include one or more components that implement functions performed by the server 120. These components may include software components, hardware components, or a combination thereof that are executable by one or more processors. A user operating the client devices 101, 102, 103, 104, 105, and/or 106 may sequentially utilize one or more client applications to interact with the server 120 to utilize the services provided by these components. It should be understood that a variety of different system configurations are possible, which may be different from the system 100. Therefore, FIG. 1 is an example of a system for implementing the various methods described herein and is not intended to be limiting.

The user may use the client devices 101, 102, 103, 104, 105, and/or 106 to input a first target image, audio data, or a display video, etc. The client devices may provide an interface that enables the user of the client devices to interact with the client devices. The client devices may also output information to the user via the interface. Although FIG. 1 depicts only six client devices, those skilled in the art will be able to understand that the present disclosure may support any number of client devices.

The client devices 101, 102, 103, 104, 105, and/or 106 may include various types of computer devices, such as portable handheld devices, general-purpose computers, such as personal computers and laptop computers, workstation computers, wearable devices, smart screen devices, self-service terminal devices, service robots, gaming systems, thin clients, various messaging devices, sensors, or other sensing devices, and the like. These computer devices may run various types and versions of software applications and operating systems, such as Microsoft Windows, Apple iOS, Unix-like operating systems, Linux or Linux-like operating systems (e.g., Google Chrome OS); or include various mobile operating systems, such as Microsoft Windows Mobile OS, iOS, Windows Phone, Android. The portable handheld devices may include cellular telephones, smart phones, tablet computers, personal digital assistants (PDAs), and the like. The wearable devices may include head-mounted displays, such as smart glasses, and other devices. The gaming systems may include various handheld gaming devices, Internet-enabled gaming devices, and the like. The client devices can perform various different applications, such as various applications related to the Internet, communication applications (e.g., e-mail applications), Short Message Service (SMS) applications, and may use various communication protocols.

The network 110 may be any type of network well known to those skilled in the art, which may support data communication using any of a variety of available protocols (including but not limited to TCP/IP, SNA, IPX, etc.). By way of example only, one or more networks 110 may be a local area network (LAN), an Ethernet-based network, a token ring, a wide area network (WAN), an Internet, a virtual network, a virtual private network (VPN), an intranet, an external network, a blockchain network, a public switched telephone network (PSTN), an infrared network, a wireless network (for example, Bluetooth, WiFi), and/or any combination of these and/or other networks.

The server 120 may include one or more general-purpose computers, a dedicated server computer (e.g., a PC (personal computer) server, a UNIX server, a mid-end server), a blade server, a mainframe computer, a server cluster, or any other suitable arrangement and/or combination. The server 120 may include one or more virtual machines running a virtual operating system, or other computing architectures involving virtualization (e.g., one or more flexible pools of a logical storage device that may be virtualized to maintain virtual storage devices of a server). In various embodiments, the server 120 may run one or more services or software applications that provide the functions described below.

The computing unit in the server 120 may run one or more operating systems including any of the operating systems described above and any commercially available server operating system. The server 120 may also run any of a variety of additional server applications and/or intermediate layer applications, including a HTTP server, an FTP server, a CGI server, a Java server, a database server, etc.

In some implementations, the server 120 may include one or more applications to analyze and merge data feeds and/or event updates received from the user of the client devices 101, 102, 103, 104, 105, and 106. The server 130 may also include one or more applications to display the data feeds and/or the real-time events via one or more display devices of the client devices 101, 102, 103, 104, 105, and 106.

In some embodiments, the server 120 may be a server of a distributed system, or a server incorporating a blockchain. The server 120 may also be a cloud server, or an intelligent cloud computing server or an intelligent cloud host with an artificial intelligence technology. The cloud server is a host product in a cloud computing service system to overcome the defects of management difficulty and weak service expansibility exiting in a traditional physical host and virtual private server (VPS) service.

The system 100 may also include one or more databases 130. In certain embodiments, these databases may be used to store data and other information. For example, one or more of the databases 130 may be used to store information such as audio files and video files. The databases 130 may reside in various locations. For example, the database used by the server 120 may be local to the server 120, or may be remote from the server 120 and may communicate with the server 120 via a network-based or dedicated connection. The databases 130 may be of different types. In some embodiments, the database used by the server 120 may be, for example, a relational database. One or more of these databases may store, update, and retrieve data to and from the database in response to a command.

In some embodiments, one or more of the databases 130 may also be used by an application to store application data. The databases used by the application may be different types of databases, such as a key-value repository, an object repository, or a conventional repository supported by a file system.

The system 100 of FIG. 1 may be configured and operated in various ways to enable application of various methods and apparatuses described according to the present disclosure.

In earlier studies, researchers achieved face reconstruction by constructing a face parametric model (e.g., 3DMM), the 3DMM can model features such as shape, expression, texture, and angle, but 3DMM-based face model rendering algorithms have poor performance and cannot achieve the generation of detailed areas such as high-precision textures and teeth.

Recently, deep learning-based approaches have been widely studied due to their excellent video generation performance, and the two most representative approaches are: one is the GAN-based approach (e.g., the StyleGAN series), the other is the diffusion model-based approach (e.g., Hallo, Follow-Your-Emoji, EchoMimic, Aniportrait, etc.). The GAN-based approach can generate more realistic portraits, however, the diversity is significantly affected by the data distribution, and the training process is unstable, being prone to model collapse. The diffusion model-based approach can generate portrait videos with high-quality, high-resolution and better diversity, however, it requires more computational resources.

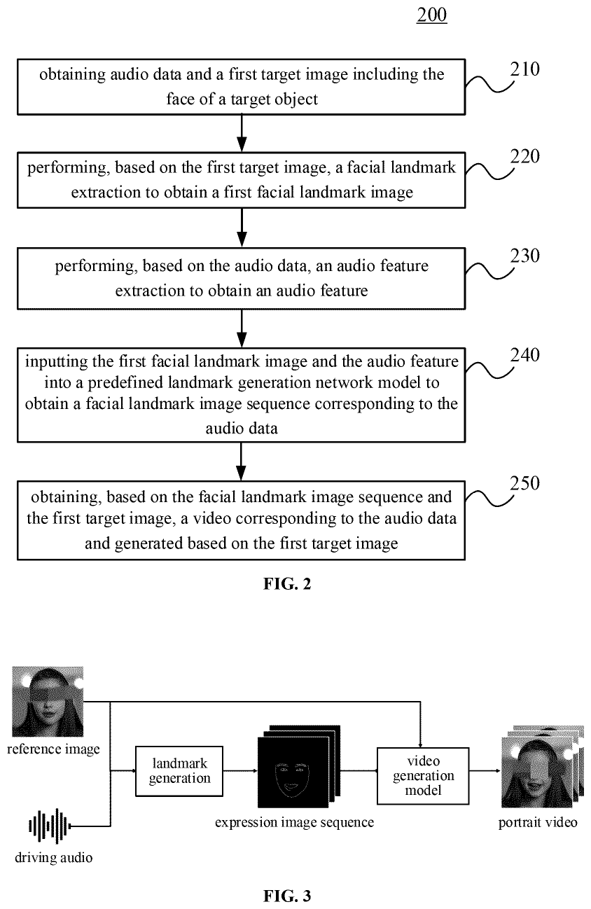

Therefore, according to the embodiments of the present disclosure, a data processing method for a virtual persona is provided to generate a corresponding audio-driven video. FIG. 2 illustrates a flowchart of a data processing method according to an embodiment of the present disclosure. As shown in FIG. 2, method 200 includes: obtaining audio data and a first target image including the face of a target object (step 210); performing, based on the first target image, a facial landmark extraction to obtain a first facial landmark image (step 220); performing, based on the audio data, an audio feature extraction to obtain an audio feature (step 230); inputting the first facial landmark image and the audio feature into a predefined landmark generation network model to obtain a facial landmark image sequence corresponding to the audio data (step 240); obtaining, based on the facial landmark image sequence and the first target image, a video corresponding to the audio data and generated based on the first target image (step 250).

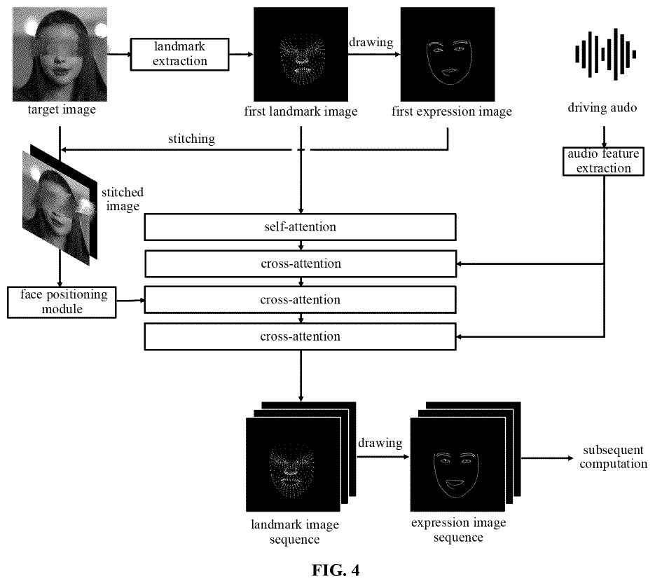

FIG. 3 illustrates a schematic diagram of a data processing method according to an embodiment of the present disclosure. As shown in FIG. 3, the generation of a landmark image is guided by inputting a target image and a driving audio. Here, as an example, a video corresponding to the audio data is generated using a video generation model based on a facial landmark image sequence and the target image (described in detail below).

According the embodiments of the present disclosure, by preprocessing the facial image of the target object and driving audio to extract the facial landmarks and the audio feature, the facial landmark image sequence is then obtained to guide the generation of the corresponding facial video, and since the computation of video generation consumes significantly more time and resources than that of facial landmark image generation, it is enabled that the generation effect of the video can be determined in advance and adjusted in a timely manner using the facial landmark image sequence, thereby saving the computational resources.

In step 210, obtaining audio data and a first target image including the face of the target object.

In the present disclosure, the audio data refers to digitized speech data. For example, the audio data may be a segment of speech data that needs to be broadcast or streamed, where the audio data is the audio that is required to be output by a virtual digital human. For example, the audio data may be speech data generated by reading a piece of text aloud; furthermore, the audio data may be speech data generated by reading the piece of text aloud with corresponding emotions, which for example include joy, sadness, anger, etc. The virtual digital human is a digital human used to broadcast the audio data, and the virtual digital human may be a two-dimensional virtual digital human generated based on the target object.

In the present disclosure, the target object is not limited to a human being but may also be an animal, or an anthropomorphized animal, an object, and the like, which is not limited herein.

For example, taking a real person as the target object as an example, when the audio data is speech data generated by reading a piece of text aloud, the generated video may be a video clip including the target object, where the facial expression dynamics of the target object in the video are consistent with the typical facial expression dynamics of the real person when reading this piece of text aloud.

In some embodiments, the generated video may not only include the face of the target object but may further include the background area in the first target image other than the face of the target object.

In step 220, performing, based on the first target image, a facial landmark detection to obtain a first facial landmark image.

Specifically, in some examples, the facial landmark detection refers to locating the positions of key landmarks regions in a facial image using an algorithm, the key landmarks regions such as the eyebrows, eyes, nose, mouth, and facial contour. During the detection process, the system returns the coordinate information of these key landmarks, thereby enabling precise identification and analysis of the face of the target object.

In some examples, in the facial landmark detection, various suitable landmark annotation approaches can be performed on the face, such as 68-point annotation, 96/98-point annotation, and 106/186-point annotation, which is not limited herein. For example, when performing 68-point annotation on the face, the facial landmarks are divided into internal landmarks and contour landmarks, the internal landmarks include a total of 51 landmarks including eyebrows, eyes, nose, and mouth, and the contour landmarks include 17 landmarks. As a result, a facial landmark image is obtained. The facial landmark image may include the coordinate information or position information of each landmark.

In some examples, in the facial landmark detection, pupil landmarks may be further included. For application scenarios related to eyes, such as face recognition, expression transformation, and eye-tracking, precise localization of pupil positions is crucial. The use of two landmarks to represent the left and right pupils can provide more accurate position information, facilitating subsequent more precise expression transformation analysis and processing.

In some examples, a three-dimensional face reconstruction technology can be used to perform a three-dimensional face reconstruction on the first target image, thereby obtaining the facial landmark image of the target object. For example, the 3D coordinates of the facial landmarks can be extracted using open-source plugins such as Media Pipe and FaceNet. Alternatively, it may be understood that it is also possible to extract the 2D coordinates of the facial landmarks using OpenCV or the like, which is not limited herein.

In step 230, performing, based on the audio data, an audio feature extraction to obtain an audio feature.

In the present disclosure, any suitable approaches can be used to perform audio feature extraction to obtain the audio feature. For example, a Mel Frequency Cepstral Coefficient (MFCC) method can be used to perform feature extraction on the audio data to obtain the audio feature, which can represent the spectral characteristics of the audio data.

In some examples, the feature extraction operation on the audio data may also be implemented using a trained neural network, such as wav2vec, whisper, etc., which is not limited herein.

In step 240, inputting the first facial landmark image and the audio feature into a predefined landmark generation network model to obtain a facial landmark image sequence corresponding to the audio data.

According to some embodiments, the predefined landmark generation network model includes: a self-attention layer and a cross-attention layer. The inputting the first facial landmark image and the audio feature into the predefined landmark generation network model to obtain the facial landmark image sequence corresponding to the audio data includes: inputting the first facial landmark image into the self-attention layer to obtain a first image feature; inputting the first image feature and the audio feature into the cross-attention layer to obtain the facial landmark image sequence corresponding to the audio data.

In this embodiment, the face landmark image sequence is obtained by extracting the image feature using the predefined self-attention layer and fusing the image feature and audio feature using the cross-attention layer.

According to some embodiments, the inputting the first image feature and the audio feature into the predefined cross-attention layer to obtain the facial landmark image sequence corresponding to the audio data includes: generating, based on the first facial landmark image, a first expression image, where the first expression image is generated based on the lines connecting the facial landmarks related to the expression in the first facial landmark image; performing a channel stitching on the first expression image and the first target image to obtain a stitched image; performing an image feature extraction on the stitched image to obtain a second image feature; and inputting the second image feature, the first image feature, and the audio feature into the predefined cross-attention layer to obtain the facial landmark image sequence corresponding to the audio data.

In this embodiment, by stitching the first expression image, generated based on the first target image, and the target image, and further inputting the image of the stitched image into the cross-attention layer to more accurately identify the face position (e.g., human face position) in the first target image and enhance the facial feature of the target object, the accuracy of the subsequently generated video is improved.

In some examples, the operation of obtaining the first image feature and/or the facial landmark image sequence can be implemented using an attention model in a Transformer model to complete the feature embedding of the audio data and the first target image and further guide the generation of the facial landmark image.

According to some embodiments, the inputting the second image feature, the first image feature, and the audio feature into the predefined cross-attention layer to obtain the facial landmark image sequence corresponding to the audio data includes: inputting the first image feature and the audio feature into a predefined first cross-attention layer to obtain a first output feature; inputting the first output feature and the second image feature into a predefined second cross-attention layer to obtain a second output feature; and inputting the second output feature and the audio feature into a predefined third cross-attention layer to obtain the face landmark image sequence corresponding to the audio data.

In step 250 obtaining, based on the facial landmark image sequence and the first target image, a video corresponding to the audio data and generated based on the first target image.

According to some embodiments, the obtaining, based on the facial landmark image sequence and the first target image, the video corresponding to the audio data and generated based on the first target image includes: generating, based on the facial landmark image sequence, an expression image sequence, where each expression image in the expression image sequence is generated based on the lines connecting the facial landmarks related to the expression in the corresponding facial landmark image; and obtaining, based on the expression image sequence and the first target image, the video corresponding to the audio data and generated based on the first target image.

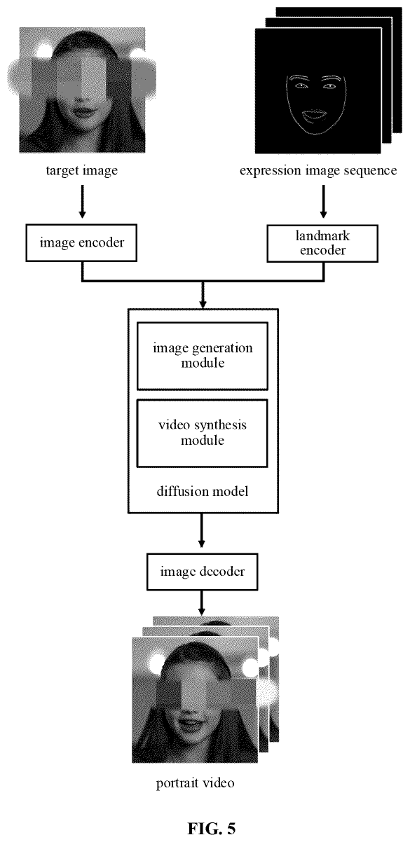

FIG. 4 illustrates a schematic diagram of a facial landmark image sequence generation model according to an embodiment of the present disclosure. As shown in FIG. 4, a facial landmark detection (i.e., landmark extraction) is performed on a first target image to obtain a first facial landmark image. A drawing is performed based on the first facial landmark image to obtain a first expression image. A channel stitching is performed on the first expression image and the first target image to obtain a stitched image. An image feature extraction is performed on the stitched image using a face localization module to obtain a second image feature; the first facial landmark image is input into a self-attention layer to extract the landmark feature to obtaining a first image feature; the output first image feature and the extracted audio feature are input into a first cross-attention layer to compute a cross-attention score of the landmark feature (i.e., the first image feature) and the audio feature to achieve audio feature embedding and obtain a first output feature; the second image feature and the first output feature are input into a second cross-attention layer to further embed the image feature in the same manner to reinforce the facial regional feature and add additional information such as identity and environment, and thereby obtaining a second output feature; the second output feature and the audio feature are input into a third cross-attention layer, and finally, audio feature embedding is performed again to enhance the effect of audio-driven, thereby obtaining a facial landmark image sequence corresponding to the audio data. Finally, corresponding expression images are drawn based on the generated facial landmark image sequence to obtain an expression image sequence.

In some examples, the expression image may include lines connecting landmarks of the eyes, mouth, eyebrows, and the facial contour part below the eyebrows or eyes. Normally, the nose part shows almost no change, or only slight changes in facial expression changes, so the nose part can be ignored in the expression image, and no lines are connected for nose landmarks.

In the above example of facial landmark detection including pupil landmarks, the expression image may further include pupil landmark information. Thereby, more accurate facial position information is provided to facilitate subsequent refined analysis and processing.

According to some embodiments, the obtaining, based on the expression image sequence and the first target image, the video corresponding to the audio data and generated based on the first target image includes: performing an image feature extraction on the first target image to obtain a third image feature; performing image feature extraction on the expression images in the expression image sequence to obtain a fourth image feature sequence; inputting the third image feature and the fourth image feature sequence into a predefined diffusion model to obtain a fifth image feature sequence; and obtaining, based on the fifth image feature sequence, the video corresponding to the audio data and generated based on the first target image.

In the present disclosure, an image feature extraction is the process of extracting useful information from an image, where the information is typically represented in the form of numerical, vectors, or symbolics and is not directly represented as the image itself. These features can facilitate a computer in “understanding” the content of the image, thereby enabling image recognition and classification. The image features typically include geometric features, shape features, amplitude features, histogram features, and color features etc.

In some examples, image feature extraction is performed on each expression image in the expression image sequence to obtain the fourth image feature sequence.

In some examples, image feature extraction is performed on the first target image using an image encoder to obtain the third image feature. The image encoder is a component for processing visual information, which converts image data into a format that can be further analyzed by the model. This typically involves feature extraction, that is involves extracting useful information from the image, such as color, texture, shape, and object locations.

According to some embodiments, the performing image feature extraction on the first target image to obtain the third image feature includes: inputting the first target image into a variational autoencoder to obtain the third image feature; and the obtaining, based on the fifth image feature sequence, the video corresponding to the audio data and generated based on the first target image includes: inputting the fifth image feature sequence into the variational autoencoder to obtain the video corresponding to the audio data and generated based on the first target image.

In some examples, image feature extraction can be performed using a deep learning-based neural network, such as a convolutional neural network (CNN). CNN automatically learn features through a multi-layer network, without requiring feature extraction rules to be manually set. VGG and ResNet are two well-known CNN architectures, which extract image features through a deep network structure.

It should be understood that the image feature extraction may be implemented using any suitable method in the embodiments of the present disclosure, which is not limited herein.

According to some embodiments, the diffusion model includes an image generation module and a video synthesis module, where the inputting the third image feature and the fourth image feature sequence into the predefined diffusion model to obtain the fifth image feature sequence includes: inputting the third image feature and the fourth image feature sequence into the image generation module to obtain a sixth image feature sequence, where each image feature in the sixth image feature sequence is a image feature corresponding to the corresponding image feature in the fourth image feature sequence and generated based on the first target image; and inputting the sixth image feature sequence into the video synthesis module to obtain the fifth image feature sequence, where the video synthesis model is used to implement the smoothness of the video generated based on the fifth image feature sequence.

According to some embodiments, the performing image feature extraction on the expression images in the expression image sequence to obtain the fourth image feature sequence includes: inputting, for the corresponding expression image in the expression image sequence, the expression image into a predefined linear attention network to obtain a corresponding image feature; and obtaining, based on the corresponding image features corresponding to the expression image sequence, the fourth image feature sequence.

FIG. 5 illustrates a schematic diagram of a video generation model for generating a video according to an embodiment of the present disclosure. As shown in FIG. 5, a first target image is input into an image encoder to obtain a third image feature; the expression image sequence is input into a landmark encoder to obtain the fourth image feature sequence; the third image feature and the fourth image feature sequence are sequentially input into an image generation module and a video synthesis module of a diffusion model to obtain the fifth image feature sequence. The fifth image feature sequence is processed by an image decoder to obtain a video generated based on the first target image. In some examples, the main body of the diffusion model can adopt a UNet framework, where the image generation module is responsible for generating the target object and the image background supplementation of a single image, and the video synthesis module is responsible for ensuring the smoothness and stableness of the entire video to be generated.

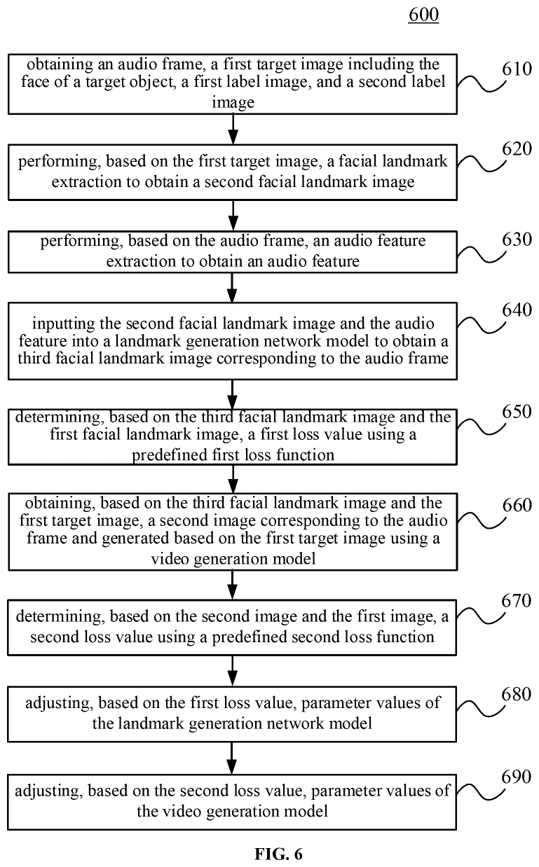

According to the embodiments of the present disclosure, as shown in FIG. 6, a model training method 600 is further provided, including: obtaining an audio frame, a first target image including the face of a target object, a first label image, and a second label image (step 610); performing, based on the first target image, a facial landmark extraction to obtain a second facial landmark image (step 620); performing, based on the audio frame, an audio feature extraction to obtain an audio feature (step 630); inputting the second facial landmark image and the audio feature into a landmark generation network model to obtain a third facial landmark image corresponding to the audio frame (step 640); determining, based on the third facial landmark image and the first facial landmark image, a first loss value using a predefined first loss function (step 650); obtaining, based on the third facial landmark image and the first target image, a second image corresponding to the audio frame and generated based on the first target image using a video generation model (step 660); determining, based on the second image and the first image, a second loss value using a predefined second loss function (step 670); adjusting, based on the first loss value, parameter values of the landmark generation network model (step 680); adjusting, based on the second loss value, parameter values of the video generation model (step 690).

In the embodiments of the present disclosure, the first label image is a first facial landmark image corresponding to the audio frame and generated based on the first target image, and the second label image is a first image corresponding to the audio frame and generated based on the first target image.

In the present disclosure, the audio frame can be obtained by frame-splitting a segment of audio data, where the audio data refers to digitized speech data. For example, the audio data may be a segment of speech data that needs to be broadcast or streamed, where the audio data is the audio that needs to be output by a virtual digital human. For example, the audio data may be speech data generated by reading a piece of text aloud; furthermore, the audio data may be speech data generated by reading the piece of text aloud with corresponding emotions, which for example include joy, sadness, anger, etc.

In the embodiments of the present disclosure, the video generation model can be trained based on the second loss function after first training the self-attention layer and the cross-attention layer based on the first loss function. That is, the self-attention layer and the cross-attention layer can be trained separately from the video generation model, or they can be trained together, which is not limited herein.

According to some embodiments, the landmark generation network model includes: a self-attention layer and a cross-attention layer. The inputting the second facial landmark image and the audio feature into the landmark generation network model to obtain the third facial landmark image corresponding to the audio frame includes: inputting the first facial landmark image into the self-attention layer to obtain a first image feature; inputting the first image feature and the audio feature into the cross-attention layer to obtain the third facial landmark image corresponding to the audio data.

According to some embodiments, the obtaining, based on the third facial landmark image and the first target image, the second image corresponding to the audio frame and generated based on the first target image using the video generation model includes: generating a first expression image based on the third facial landmark image, where the first expression image is generated based on the lines connecting the facial landmarks related to the expression in the third facial landmark image; inputting the first expression image and the first target image into the video generation model to obtain a second image corresponding to the audio frame and generated based on the first target image. According to some embodiments, the inputting the first image feature and the audio feature into the cross-attention layer to obtain the third facial landmark image corresponding to the audio frame includes: generating a second expression image based on the second facial landmark image, where the second expression image is generated based on the lines connecting the facial landmarks related to the expression in the second facial landmark image; performing a channel stitching on the second expression image and the first target image to obtain a stitched image; inputting the stitched image into a face positioning module to obtain a second image feature; and inputting the first image feature, the second image feature, and the audio feature into the cross-attention layer to obtain the third facial landmark image corresponding to the audio frame.

According to some embodiments, the adjusting, based on the first loss value, the parameter values of the landmark generation network model includes: adjusting, based on the first loss value, the parameter values of the self-attention layer, the cross-attention layer, and the face positioning module.

According to some embodiments, the cross-attention layer includes a first cross-attention layer, a second cross-attention layer, and a third cross-attention layer. The inputting the first image feature and the audio feature into the cross-attention layer to obtain the third face landmark image corresponding to the audio frame includes: inputting the first image feature and the audio feature into the first cross-attention layer to obtain a first output feature; inputting the first output feature and the second image feature into the second cross-attention layer to obtain a second output feature; and inputting the second output feature and the audio feature into the third cross-attention layer to obtain the third face landmark image corresponding to the audio frame.

According to some embodiments, the video generation model includes a first image encoder, a second image encoder, a diffusion model, and an image decoder. The inputting the first expression image and the first target image into the video generation model to obtain the second image corresponding to the audio frame and generated based on the first target image includes: inputting the first target image into the first image encoder to obtain a third image feature; inputting the first expression image into the second image encoder to obtain a fourth image feature; inputting the third image feature and the fourth image feature into the diffusion model to obtain a fifth image feature; and inputting the fifth image feature into the image decoder to obtain the second image corresponding to the audio frame and generated based on the first target image.

According to some embodiments, the adjusting, based on the second loss value, the parameter values of the video generation model includes: adjusting, based on the second loss value, the parameter values of the second image encoder and the diffusion model.

According to some embodiments, the diffusion model includes an image generation module and a video synthesis module, where the inputting the third image feature and the fourth image feature into the diffusion model to obtain the fifth image feature includes: inputting the third image feature and the fourth image feature into the image generation module to obtain a sixth image feature, where the sixth image feature is an image feature corresponding to the fourth image feature and generated based on the first target image; and inputting the sixth image feature into the video synthesis module to obtain the fifth image feature, where the video synthesis model is used to implement the smoothness of the video when generating a video based on a plurality of the fourth image features.

According to some embodiments, the adjusting, based on the second loss value, the parameter values of the video generation model includes: adjusting, based on the second loss value, the parameter values of the second image encoder and the image generation module.

According to some embodiments, the model training method according to the present disclosure further includes: obtaining a plurality of second expression images, a second target image including the face of the target object, and a plurality of third label images that are in one-to-one correspondence with the plurality of second expression images, where each of the plurality of second expression images is generated based on the lines connecting the facial landmarks related to the expressions in the corresponding facial landmark image; inputting the second target image into the first image encoder to obtain a seventh image feature; inputting the plurality of second expression images into the second image encoder to obtain a plurality of eighth image features; inputting the seventh image feature and the plurality of eighth image features into the image generation module to obtain a plurality of ninth image features, where the plurality of ninth image features and the plurality of eighth image features are in one-to-one correspondence; and inputting the plurality of ninth image features into the video synthesis module to obtain a plurality of tenth image features; inputting the plurality of tenth image features into the image decoder to obtain a plurality of third images; determining, based on the plurality of third images and the plurality of third label images, a third loss value using the predefined second loss function; and adjusting the parameter values of the video synthesis module based on the third loss value.

Specifically, in some examples, the training of the video generation model can be divided into two stages. That is, in the first stage, the second image encoder and the image generation module are trained based on single-frame expression image; in the second stage, the video synthesis module is trained based on multi-frame expression images to improve the smoothness of the generated video.

According to some embodiments, the second image encoder includes a linear attention network.

According to some embodiments, the predefined first loss function loss1 is determined based on the following equation:

$$loss 1 = {a}_{1} \times {\sum }_{i = 1}^{{n}_{1}} ( {A}_{i} - {\overline{A}}_{i} ) + {b}_{1} \times {\sum }_{j = 1}^{{n}_{2}} ( {B}_{j} - {\overline{B}}_{j} )$$

where Āᵢ represents the coordinate information of the ith facial landmark in the first facial landmark image, Aᵢ represents the coordinate information of the ith facial landmark in the third facial landmark image, n₁ represents the number of facial landmarks in the first facial landmark image and the third facial landmark image, Bⱼ represents the coordinate information of the jth landmark related to the mouth in the third facial landmark image, Bⱼ represents the coordinate information of the jth landmark related to the mouth in the first facial landmark image, n₂ indicating the number of landmarks related to the mouth in the first facial landmark image and the third facial landmark image, both a₁ and b₁ are predefined hyperparameters.

According to some embodiments, the predefined second loss function loss2 is determined based on the following equation:

$$loss 2 = {a}_{2} \times ( C - \overline{C} ) + {b}_{2} \times ( D \times C - D \times \overline{C} )$$

where C̅ represents the first image or the corresponding third label image, C represents the second image or the corresponding third image, D represents the mouth mask image, both a₂ and b₂ are predefined hyperparameters.

In some examples, when C̅ represents the corresponding third label image in the plurality of third label images and C represents the corresponding third image in the plurality of third images, the loss value corresponding to each image of the plurality of third label images/third images can be computed using the above equation, and by summing the respective corresponding loss values of the plurality of third label images/third images, the third loss value is obtained to adjust the parameter values of the video synthesis module based on the third loss value.

In this embodiment, to improve the clarity and stability of tooth generation, a mouth mask loss and an overall image loss are used to supervise the model training at the same time. Furthermore, in some examples, by setting appropriate values for a₂ and b₂, the weight of the mouth mask loss can be increased to further improve the clarity and stability of tooth generation.

In the present disclosure, a model trained by a model training method according to any one of the above embodiments may be used to implement the data processing method described in any embodiment of the present disclosure.

Herein, the embodiments for implementing the model training method and the embodiments for implementing the data processing method have similar corresponding operations, and details are not described herein again.

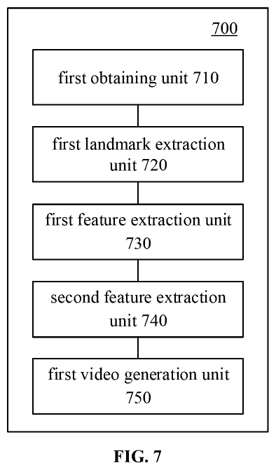

According to the embodiments of the present disclosure, as shown in FIG. 7, a data processing apparatus 700 for a virtual persona is also provided, including: a first obtaining unit 710 configured to obtain audio data and a first target image including the face of a target object; a first landmark extraction unit 720 configured to perform, based on the first target image, a facial landmark extraction to obtain a first facial landmark image; a first feature extraction unit 730 configured to perform, based on the audio data, an audio feature extraction to obtain an audio feature; a second feature extraction unit 740 configured to input the first facial landmark image and the audio feature into a predefined landmark generation network model to obtain a facial landmark image sequence corresponding to the audio data; and a first video generation unit 750 configured to obtain, based on the facial landmark image sequence and the first target image, a video corresponding to the audio data and generated based on the first target image.

Here, the operations of each of the units 710 to 750 of the data processing apparatus 700 are similar to the operations described in steps 210 to 250 respectively, and details are not described herein again.

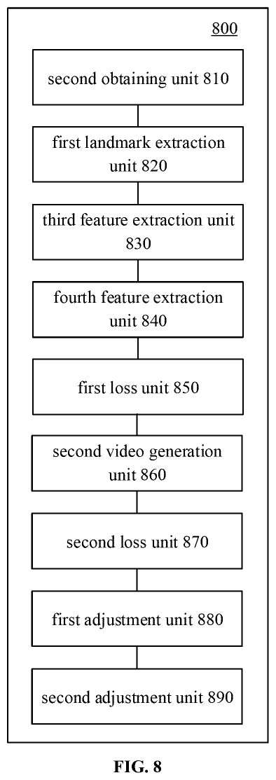

According to the embodiments of the present disclosure, as shown in FIG. 8, a model training apparatus 800 is further provided, including: a second obtaining unit 810 configured to obtain an audio frame, a first target image including the face of a target object, a first label image, and a second label image, where the first label image is a first face landmark image corresponding to the audio frame and generated based on the first target image, and the second label image is a first image corresponding to the audio frame and generated based on the first target image; a first landmark extraction unit 820 configured to perform, based on the first target image, a facial landmark extraction to obtain a second facial landmark image; a third feature extraction unit 830 configured to perform, based on the audio frame, an audio feature extraction to obtain an audio feature; a fourth feature extraction unit 840 configured to input the second facial landmark image and the audio feature into a landmark generation network model to obtain a third facial landmark image corresponding to the audio frame; a first loss unit 850 configured to determine, based on the third facial landmark image and the first facial landmark image, a first loss value using a predefined first loss function; a second video generation unit 860 configured to obtain, based on the third facial landmark image and the first target image, a second image corresponding to the audio frame and generated based on the first target image using a video generation model; a second loss unit 870 configured to determine, based on the second image and the first image, a second loss value using a predefined second loss function; a first adjustment unit 880 configured to adjust, based on the first loss value, parameter values of the landmark generation network model; and a second adjustment unit 890 configured to adjust, based on the second loss value, parameter values of the video generation model.

Herein, the operations of the units 810 to 890 of the model training apparatus 800 are similar to the operations described in steps 610 to 690 above and are details are not repeated herein.

In the technical solution of the present disclosure, the collection, storage, use, processing, transmission, provision, and disclosure of user's personal information are all in compliance with relevant laws and regulations and do not violate public order and good morals.

According to the embodiments of the present disclosure, an electronic device, a computer-readable storage medium, and a computer program product are also provided.

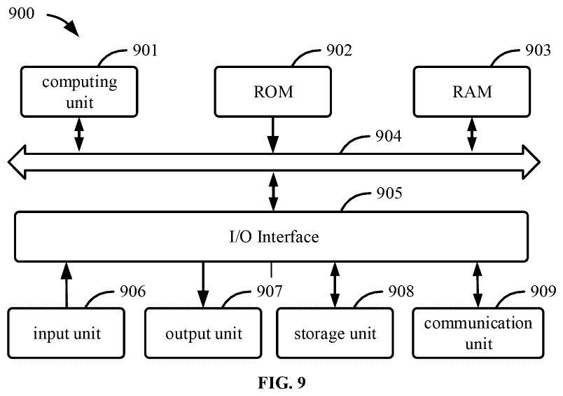

Referring to FIG. 9, a structural block diagram of an electronic device 900 that may be a server or client of the present disclosure is now described, which is an example of a hardware device that may be applied to aspects of the present disclosure. Electronic devices are intended to represent various forms of digital electronic computer devices, such as laptop computers, desktop computers, workstations, personal digital assistants, servers, blade servers, mainframe computers, and other suitable computers. The electronic devices may also represent various forms of mobile devices, such as personal digital processing, cellular telephones, smart phones, wearable devices, and other similar computing devices. The components shown herein, their connections and relationships, and their functions are merely as examples, and are not intended to limit the implementations of the disclosure described and/or claimed herein.

As shown in FIG. 9, the electronic device 900 includes a computing unit 901, which may perform various appropriate actions and processing according to a computer program stored in a read-only memory (ROM) 902 or a computer program loaded into a random access memory (RAM) 903 from a storage unit 908. In the RAM 903, various programs and data required by the operation of the electronic device 900 may also be stored. The computing unit 901, the ROM 902, and the RAM 903 are connected to each other through a bus 904. Input/output (I/O) interface 905 is also connected to the bus 904.

A plurality of components in the electronic device 900 are connected to a I/O interface 905, including: an input unit 906, an output unit 907, a storage unit 908, and a communication unit 909. The input unit 906 may be any type of device capable of inputting information to the electronic device 900, the input unit 906 may receive input digital or character information and generate a key signal input related to user setting and/or function control of the electronic device, and may include, but is not limited to, a mouse, a keyboard, a touch screen, a track pad, a trackball, a joystick, a microphone, and/or a remote control. The output unit 907 may be any type of device capable of presenting information, and may include, but are not limited to, a display, a speaker, a video/audio output terminal, a vibrator, and/or a printer. The storage unit 908 may include, but is not limited to, a magnetic disk and an optical disk. The communication unit 909 allows the electronic device 900 to exchange information/data with other devices over a computer network, such as the Internet, and/or various telecommunication networks, and may include, but is not limited to, a modem, a network card, an infrared communication device, a wireless communication transceiver and/or a chipset, such as a Bluetooth device, a 802.11 device, a WiFi device, a WiMAX device, a cellular communication device, and/or the like.

The computing unit 901 may be a variety of general and/or special purpose processing components with processing and computing capabilities. Some examples of the computing unit 901 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, etc. The computing unit 901 performs the various methods and processes described above, such as the method 200 or 600. For example, in some embodiments, the method 200 or 600 described above may be implemented as a computer software program tangibly contained in a machine-readable medium, such as the storage unit 908. In some embodiments, part or all of the computer program may be loaded and/or installed onto the electronic device 900 via the ROM 902 and/or the communication unit 909. When the computer program is loaded to the RAM 903 and executed by the computing unit 901, one or more steps of the method 200 or 600 described above may be performed. Alternatively, in other embodiments, the computing unit 901 may be configured to perform the method 200 or 600 described above by any other suitable means (e.g., with the aid of firmware).

Various embodiments of the systems and techniques described above herein may be implemented in a digital electronic circuit system, an integrated circuit system, a field programmable gate array (FPGA), an application specific integrated circuit (ASIC), a dedicated standard product (ASSP), a system of system on a chip system (SoC), a complex programmable logic device (CPLD), computer hardware, firmware, software, and/or combinations thereof. These various embodiments may include: implementation in one or more computer programs that may be executed and/or interpreted on a programmable system including at least one programmable processor, where the programmable processor may be a dedicated or universal programmable processor that may receive data and instructions from a storage system, at least one input device, and at least one output device, and transmit data and instructions to the storage system, the at least one input device, and the at least one output device.

The program code for implementing the method of the present disclosure may be written in any combination of one or more programming languages. These program code may be provided to a processor or controller of a general-purpose computer, a special purpose computer, or other programmable data processing device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium, which may contain or store a program for use by or in connection with an instruction execution system, device, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of a machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

To provide interaction with a user, the systems and techniques described herein may be implemented on a computer having: a display device (e.g., a CRT (cathode ray tube) or an LCD (liquid crystal display) monitor) for displaying information to a user; and a keyboard and pointing device (e.g., a mouse or trackball) by which a user may provide input to the computer. Other types of devices may also be used to provide interaction with a user; for example, the feedback provided to the user may be any form of perception feedback (e.g., visual feedback, auditory feedback, or tactile feedback); and the input from the user may be received in any form, including acoustic input, voice input, or haptic input.

The systems and techniques described herein may be implemented in a computing system including a back-end component (e.g., as a data server), or a computing system including a middleware component (e.g., an application server), or a computing system including a front-end component (e.g., a user computer with a graphic user interface or a web browser, the user may interact with implementations of the systems and techniques described herein through the graphic user interface or the web browser), or in a computing system including any combination of such back-end components, middleware components, or front-end components. The components of the system may be interconnected by digital data communication (e.g., a communications network) in any form or medium. Examples of communication networks include a local area network (LAN), a wide area network (WAN), the Internet, and a blockchain network.

The computer system may include a client and a server. Clients and servers are generally remote from each other and typically interact through a communication network. The relationship between clients and servers is generated by computer programs running on respective computers and having a client-server relationship to each other. The server may be a cloud server, or may be a server of a distributed system, or a server incorporating a blockchain.

It should be understood that the various forms of processes shown above may be used, and the steps may be reordered, added, or deleted. For example, the steps described in the present disclosure may be performed in parallel or sequentially or in a different order, as long as the results expected by the technical solutions disclosed in the present disclosure can be achieved, and no limitation is made herein.

Although embodiments or examples of the present disclosure have been described with reference to the accompanying drawings, it should be understood that the foregoing methods, systems, and devices are merely embodiments or examples, and the scope of the present disclosure is not limited by these embodiments or examples, but is only defined by the authorized claims and their equivalents. Various elements in the embodiments or examples may be omitted or may be replaced by equivalent elements thereof. Further, the steps may be performed by a different order than described in this disclosure. Further, various elements in the embodiments or examples may be combined in various ways. Importantly, with the evolution of the technology, many elements described herein may be replaced by equivalent elements appearing after the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data processing method for a virtual persona, comprising:
obtaining audio data and a first target image including the face of a target object;
performing, based on the first target image, a facial landmark extraction to obtain a first facial landmark image;
performing, based on the audio data, an audio feature extraction to obtain an audio feature;
inputting the first facial landmark image and the audio feature into a predefined landmark generation network model to obtain a facial landmark image sequence corresponding to the audio data; and
obtaining, based on the facial landmark image sequence and the first target image, a video corresponding to the audio data and generated based on the first target image.

2. The method of claim 1, wherein the predefined landmark generation network model comprises:
a self-attention layer and a cross-attention layer, wherein the inputting the first facial landmark image and the audio feature into the predefined landmark generation network model to obtain the facial landmark image sequence corresponding to the audio data comprises:
inputting the first facial landmark image into the self-attention layer to obtain a first image feature; and
inputting the first image feature and the audio feature into the cross-attention layer to obtain the facial landmark image sequence corresponding to the audio data.

3. The method of claim 1, wherein the obtaining, based on the facial landmark image sequence and the first target image, the video corresponding to the audio data and generated based on the first target image comprises:
generating, based on the facial landmark image sequence, an expression image sequence, wherein the expression image in the expression image sequence is generated based on lines connecting the facial landmarks related to the expression in the corresponding facial landmark image; and
obtaining, based on the expression image sequence and the first target image, the video corresponding to the audio data and generated based on the first target image.

4. The method of claim 2, wherein the inputting the first image feature and the audio feature into the cross-attention layer to obtain the facial landmark image sequence corresponding to the audio data comprises:
generating, based on the first facial landmark image, a first expression image, where the first expression image is generated based on the lines connecting the facial landmarks related to the expression in the first facial landmark image;
performing a channel stitching on the first expression image and the first target image to obtain a stitched image;
performing an image feature extraction on the stitched image to obtain a second image feature; and
inputting the second image feature, the first image feature, and the audio feature into the predefined cross-attention layer to obtain the facial landmark image sequence corresponding to the audio data.

5. The method of claim 4, wherein the cross-attention layer comprises a first cross-attention layer, a second cross-attention layer, and a third cross-attention layer, and wherein the inputting the second image feature, the first image feature, and the audio feature into the predefined cross-attention layer to obtain the facial landmark image sequence corresponding to the audio data comprises:
inputting the first image feature and the audio feature into the predefined first cross-attention layer to obtain a first output feature;
inputting the first output feature and the second image feature into the predefined second cross-attention layer to obtain a second output feature; and
inputting the second output feature and the audio feature into the predefined third cross-attention layer to obtain the face landmark image sequence corresponding to the audio data.

6. The method of claim 3, wherein the obtaining, based on the expression image sequence and the first target image, the video corresponding to the audio data and generated based on the first target image comprises:
performing an image feature extraction on the first target image to obtain a third image feature;
performing an image feature extraction on the expression images in the expression image sequence to obtain a fourth image feature sequence;
inputting the third image feature and the fourth image feature sequence into a predefined diffusion model to obtain a fifth image feature sequence; and
obtaining, based on the fifth image feature sequence, the video corresponding to the audio data and generated based on the first target image.

7. The method of claim 6, wherein the diffusion model comprises an image generation module and a video synthesis module, and wherein the inputting the third image feature and the fourth image feature sequence into the predefined diffusion model to obtain the fifth image feature sequence comprises:
inputting the third image feature and the fourth image feature sequence into the image generation module to obtain a sixth image feature sequence, wherein the image feature in the sixth image feature sequence is the image feature corresponding to the corresponding image feature in the fourth image feature sequence and generated based on the first target image; and
inputting the sixth image feature sequence into the video synthesis module to obtain the fifth image feature sequence, wherein the video synthesis model is used to enable the smoothness of the video generated based on the fifth image feature sequence.

8. The method of claim 6, wherein
the performing image feature extraction on the first target image to obtain the third image feature comprises: inputting the first target image into a variational autoencoder to obtain the third image feature; and
the obtaining, based on the fifth image feature sequence, the video corresponding to the audio data and generated based on the first target image comprises: inputting the fifth image feature sequence into the variational autoencoder to obtain the video corresponding to the audio data and generated based on the first target image.

9. The method of claim 6, wherein the performing an image feature extraction on the expression images in the expression image sequence to obtain the fourth image feature sequence comprises:
inputting, for respective expression image in the expression image sequence, the expression image into a predefined linear attention network to obtain a corresponding image feature; and
obtaining, based on the corresponding image features corresponding to the expression image sequence, the fourth image feature sequence.

10. A model training method, comprising:
obtaining an audio frame, a first target image including the face of a target object, a first label image, and a second label image, wherein the first label image is a first face landmark image corresponding to the audio frame and generated based on the first target image, and the second label image is a first image corresponding to the audio frame and generated based on the first target image;
performing, based on the first target image, a facial landmark extraction to obtain a second facial landmark image;
performing, based on the audio frame, an audio feature extraction to obtain an audio feature;
inputting the second facial landmark image and the audio feature into a landmark generation network model to obtain a third facial landmark image corresponding to the audio frame; and
determining, based on the third facial landmark image and the first facial landmark image, a first loss value using a predefined first loss function;
obtaining, based on the third facial landmark image and the first target image, a second image corresponding to the audio frame and generated based on the first target image using a video generation model;
determining, based on the second image and the first image, a second loss value using a predefined second loss function;
adjusting, based on the first loss value, parameter values of the landmark generation network model; and
adjusting, based on the second loss value, parameter values of the video generation model.

11. The method of claim 10, wherein the landmark generation network model comprises: a self-attention layer and a cross-attention layer, wherein the inputting the second facial landmark image and the audio feature into the landmark generation network model to obtain the third facial landmark image corresponding to the audio frame comprises:
inputting the second facial landmark image into the self-attention layer to obtain a first image feature;
inputting the first image feature and the audio feature into the cross-attention layer to obtain the third facial landmark image corresponding to the audio frame.

12. The method of claim 10, wherein the obtaining, based on the third facial landmark image and the first target image, the second image corresponding to the audio frame and generated based on the first target image using the video generation model comprises:
generating, based on the third facial landmark image, a first expression image, wherein the first expression image is generated based on the lines connecting the facial landmarks related to the expression in the third facial landmark image;
inputting the first expression image and the first target image into the video generation model to obtain a second image corresponding to the audio frame and generated based on the first target image.

13. The method of claim 11, wherein the inputting the first image feature and the audio feature into the cross-attention layer to obtain the third facial landmark image corresponding to the audio frame comprises:
generating, based on the second facial landmark image, a second expression image, wherein the second expression image is generated based on the lines connecting the facial landmarks related to the expression in the second facial landmark image;
performing a channel stitching on the second expression image and the first target image to obtain a stitched image;
inputting the stitched image into a face positioning module to obtain a second image feature; and
inputting the first image feature, the second image feature, and the audio feature into the cross-attention layer to obtain the third facial landmark image corresponding to the audio frame.

14. The method of claim 13, wherein the adjusting, based on the first loss value, the parameter values of the landmark generation network model comprises: adjusting, based on the first loss value, the parameter values of the self-attention layer, the cross-attention layer, and the face positioning module.

15. The method of claim 13, wherein the cross-attention layer includes a first cross-attention layer, a second cross-attention layer, and a third cross-attention layer, and wherein the inputting the first image feature and the audio feature into the cross-attention layer to obtain the third face landmark image corresponding to the audio frame comprises:
inputting the first image feature and the audio feature into the first cross-attention layer to obtain a first output feature;
inputting the first output feature and the second image feature into the second cross-attention layer to obtain a second output feature; and
inputting the second output feature and the audio feature into the third cross-attention layer to obtain the third face landmark image corresponding to the audio frame.

16. The method of claim 12, wherein the video generation model includes a first image encoder, a second image encoder, a diffusion model, and an image decoder, and wherein the inputting the first expression image and the first target image into the video generation model to obtain the second image corresponding to the audio frame and generated based on the first target image comprises:
inputting the first target image into the first image encoder to obtain a third image feature;
inputting the first expression image into the second image encoder to obtain a fourth image feature;
inputting the third image feature and the fourth image feature into the diffusion model to obtain a fifth image feature; and
inputting the fifth image feature into the image decoder to obtain the second image corresponding to the audio frame and generated based on the first target image.

17. The method of claim 16, wherein the adjusting, based on the second loss value, the parameter values of the video generation model comprises: adjusting, based on the second loss value, the parameter values of the second image encoder and the diffusion model.

18. The method of claim 16, wherein the diffusion model includes an image generation module and a video synthesis module, wherein the inputting the third image feature and the fourth image feature into the diffusion model to obtain the fifth image feature comprises:
inputting the third image feature and the fourth image feature into the image generation module to obtain a sixth image feature, wherein the sixth image feature is an image feature corresponding to the fourth image feature and generated based on the first target image; and
inputting the sixth image feature into the video synthesis module to obtain the fifth image feature, wherein the video synthesis model is used to enable the smoothness of the video when generating the video based on a plurality of the fourth image features.

19. The method of claim 18, wherein the adjusting, based on the second loss value, the parameter values of the video generation model comprises: adjusting, based on the second loss value, the parameter values of the second image encoder and the image generation module.

20. The method of claim 18, further comprising:
obtaining a plurality of second expression images, a second target image including the face of the target object, and a plurality of third label images that are in one-to-one correspondence with the plurality of second expression images, wherein the second expression image of the plurality of second expression images is generated based on the lines connecting the facial landmarks related to the expression in the corresponding facial landmark image;
inputting the second target image into the first image encoder to obtain a seventh image feature;
inputting the plurality of second expression images into the second image encoder to obtain a plurality of eighth image features;
inputting the seventh image feature and the plurality of eighth image features into the image generation module to obtain a plurality of ninth image features, wherein the plurality of ninth image features and the plurality of eighth image features are in one-to-one correspondence; and
inputting the plurality of ninth image features into the video synthesis module to obtain a plurality of tenth image features;
inputting the plurality of tenth image features into the image decoder to obtain a plurality of third images;
determining, based on the plurality of third images and the plurality of third label images, a third loss value using the predefined second loss function; and
adjusting, based on the third loss value, the parameter values of the video synthesis module.

21. The method of claim 16, wherein the second image encoder comprises a linear attention network.

22. The method of claim 10, wherein the predefined first loss function loss1 is determined based on the following equation:
$$loss 1 = {a}_{1} \times {\sum }_{i = 1}^{{n}_{1}} ( {A}_{i} - {\overline{A}}_{i} ) + {b}_{1} \times {\sum }_{j = 1}^{{n}_{2}} ( {B}_{j} - {\overline{B}}_{j} )$$
wherein Āᵢ represents the coordinate information of the ith facial landmark in the first facial landmark image, Aᵢ represents the coordinate information of the ith facial landmark in the third facial landmark image, n₁ represents the number of facial landmarks in the first facial landmark image and the third facial landmark image, Bⱼ represents the coordinate information of the jth landmark related to the mouth in the third facial landmark image, B̅ⱼ represents the coordinate information of the jth landmark related to the mouth in the first facial landmark image, n₂ indicating the number of landmarks related to the mouth in the first facial landmark image and the third facial landmark image, both a₁ and b₁ are predefined hyperparameters.

23. The method of claim 20, wherein the predefined second loss function loss2 is determined based on the following equation:
$$loss 2 = {a}_{2} \times ( C - \overline{C} ) + {b}_{2} \times ( D \times C - D \times \overline{C} )$$
wherein C̅ represents the first image or the corresponding third label image, C represents the second image or the corresponding third image, D represents the mouth mask image, both a₂ and b₂ are predefined hyperparameters.

24. An electronic device, comprising:
a memory storing one or more programs configured to be executed by one or more processors, the one or more programs including instructions for performing operations comprising:
obtaining audio data and a first target image including the face of a target object;
performing, based on the first target image, a facial landmark extraction to obtain a first facial landmark image;
performing, based on the audio data, an audio feature extraction to obtain an audio feature;
inputting the first facial landmark image and the audio feature into a predefined landmark generation network model to obtain a facial landmark image sequence corresponding to the audio data; and
obtaining, based on the facial landmark image sequence and the first target image, a video corresponding to the audio data and generated based on the first target image.
